(19) United States
(12) Patent Application Publication
(10) Pub. No.: US 2007/0016393 A1
(43) Pub. Date: Jan. 18, 2007

(54) Model-based propagation of attributes

(75) Inventors: Anders B. Vinberg, Kirkland, WA (US); Anand Lakshminarayanan, Redmond, WA (US); Ashvinkumar J. Sanghvi, Sammamish, WA (US); Vij Rajarajan, Issaquah, WA (US); Vitaly J. Voloshin, Issaquah, WA (US); Bassam Tabbara, Seattle, WA (US); Kevin Grealish, Seattle, WA (US); Rob Mensching, Redmond, WA (US); Geoffrey Outhred, Seattle, WA (US); Galen Hunt, Bellevue, WA (US); Aamer Hydrie, Seattle, WA (US); Robert Welland, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/170,715

(22) Filed: Jun. 29, 2005

(51) Int. Cl. G06F 17/50

(52) U.S. Cl. 703/13

(57) ABSTRACT

Model-based propagation of attributes allows a user to define one or more attributes, policies associated with the system and particular components, constraints associated with various components, and dependencies between components of the system. The user also defines the manner in which the attributes are to be propagated throughout a model of the system. The attributes are then propagated to the appropriate components in the model using information associated with the model of the system.

### BACKGROUND

Computers have become increasingly commonplace in our world and offer a variety of different functionality. Some computers are designed primarily for individual use, while others are designed primarily to be accessed by multiple users and/or multiple other computers concurrently. These different functionalities are realized by the use of different hardware components as well as different software applications that are installed on the computers.

Although the variety of available computer functionality and software applications is a tremendous benefit to the end users of the computers, such a wide variety can be problematic for the developers of the software applications as well as system administrators that are tasked with keeping computers running. Many computing systems contain a large number of different components that must work together and function properly for the entire computing system to operate properly. The demands on a computing system vary depending on one or more factors, such as the number of users accessing the computing system, the number of applications running on the computing system, the number of tasks or operations being performed by the computing system, and the capacities of various components in the computing system. System administrators need to configure and equip computing systems to handle current processing loads and, at times, may need to re-configure or plan for future processing requirements (e.g., due to additional users, increased numbers of tasks or operations being performed, and the like).

To assist system administrators with managing computer systems, it would be beneficial to provide system administrators with a mechanism for propagating various attributes throughout a system model.

### SUMMARY

Model-based propagation of attributes is described herein. A user can define one or more attributes, policies associated with the system and particular components, constraints associated with various components, and relationships and dependencies between components of the system. The user also defines the manner in which attributes are to be propagated throughout a system model. The attributes are then propagated among the objects in the model, and these propagated attributes are used in policy validation and other management purposes.

### BRIEF DESCRIPTION OF THE DRAWINGS

The same numbers are used throughout the drawings to reference like features.

FIG. 1 illustrates an example system definition model (SDM) that can be used with the model-based system monitoring described herein.

FIG. 2 illustrates an example use of types, configurations, and instances.

FIG. 3 is a flowchart illustrating an example process for propagating attributes throughout a system model.

FIG. 4 illustrates an example attribute propagation module that receives a system model and various attributes, and propagates attributes throughout the model.

FIG. 5 illustrates an example general computer environment, which can be used to implement the techniques described herein.

### DETAILED DESCRIPTION

Model-based propagation of attributes is described herein. A user, such as a system administrator, can define one or more attributes associated with the system or associated with particular components in the system. The model consists of systems (or components) and relationships between those systems or components. Each system and each relationship may have one or more associated constraints. A constraint is a statement (e.g., a rule) that something must be true. For example, a constraint may state that a SQL Server database must use a RAID (Redundant Array of Independent Disks) storage subsystem to host its data. A constraint, or several constraints taken together, are often referred to as a policy, indicating that the constraints are associated with operational policies of, for example, the IT staff rather than the technical characteristics of the system. Systems and components may also have associated attributes, such as a business-importance attribute.

A constraint can “flow” over a relationship between two systems or components, such as a constraint on an application that makes a statement on how the operating system on which the application is hosted should be configured. Additionally, attributes can propagate over one or more relationships to provide a more meaningful policy, as discussed in greater detail below. Although particular constraints, policies, and attributes are discussed herein, alternate embodiments may include additional constraints, policies, or attributes, or may omit certain constraints, policies, or attributes discussed herein. Although a particular model is described herein, alternate embodiments may use any type of model having any type of structure for defining components in a system.

A system definition model (SDM) describes a system that can be managed. Management of a system can include, for example, installing software on the system, monitoring the performance of the system, maintaining configuration information about the system, verifying that constraints within the system are satisfied, combinations thereof, and so forth. A system can be, for example, an application, a single computing device, multiple computing devices networked together (e.g., via a private or personal network such as a local area network (LAN) or via a larger network such as the Internet), and so forth.

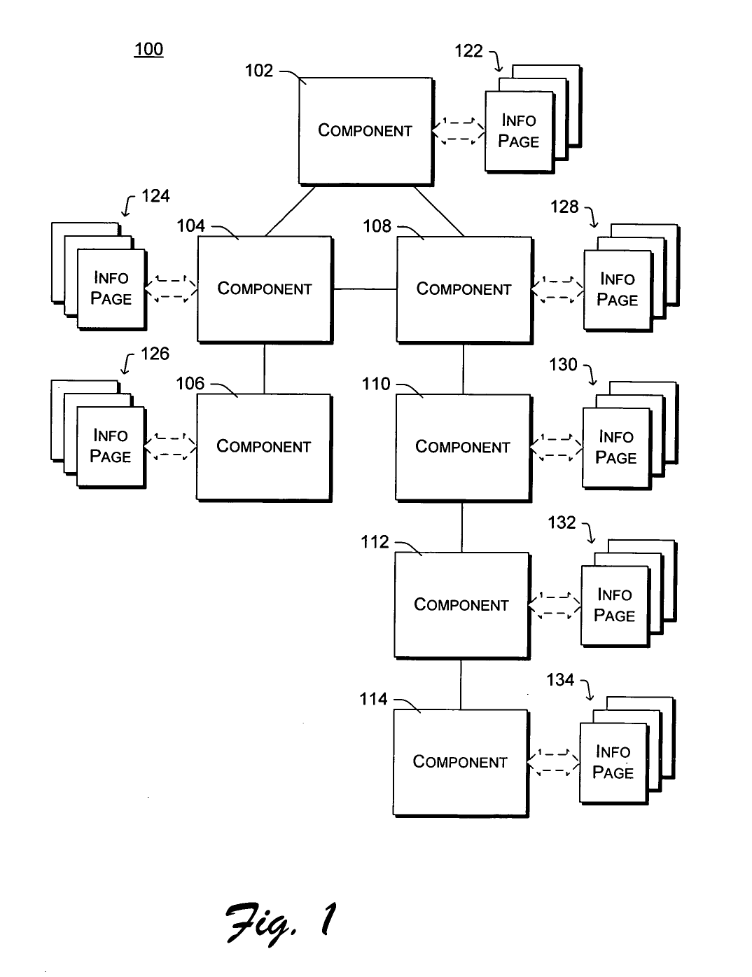

FIG. 1 illustrates an example SDM 100 that can be used with the model-based propagation of attributes described herein. SDM 100 includes a component corresponding to each software and/or hardware component in a system. Examples of hardware and/or software components that could be in a system include an application (such as a database application, email application, file server application, game, productivity application, operating system, and so forth), particular hardware on a computer (such as a network card, a hard disk drive, one of multiple processors, and so forth), a virtual machine, a computer, a group of multiple computers, and so on. A system refers to a collection of one or more hardware and/or software components.

SDM 100 represents a system including component 102, component 104, component 106, component 108, component 110, component 112, and component 114. Although the example SDM 100 includes seven components, in practice a system, and thus the SDM, can include any number of components. Each hardware or software component being managed in a system is represented by a component in SDM 100.

For example, component 106 could represent a particular computer, while component 104 represents an operating system running on that particular computer. By way of another example, component 106 could represent an operating system, while component 104 represents a database application running on the operating system. By way of yet another example, component 114 could represent a particular computer, while component 112 represents an operating system installed on that particular computer, component 110 represents a virtual machine running on the operating system, and component 108 represents an operating system running on the virtual machine. Note that the operating systems associated with component 112 and component 108 could be the same or alternatively two different operating systems.

The SDM is intended to be a comprehensive knowledge store, containing all information used in managing the system. This information includes information regarding the particular components in the system, as well as relationships among the various components in the system. Despite this intent, it is to be appreciated that the SDM may contain only some of the information used in managing the system rather than all of the information.

Relationships can exist between different components in a system, and these relationships are illustrated in the SDM with lines connecting the related components. Examples of relationships that can exist between components include containment relationships, hosting relationships, and communication relationships. Containment relationships identify one component as being contained by another component—data and definitions of the component being contained are incorporated into the containing component. When one component is contained by another component, that other component can control the lifetime of the contained component, can control the visibility of the contained component, and can delegate behavior to the contained component. In FIG. 1, containment relationships are illustrated by the diagonal lines connecting component 102 and component 104, and connecting component 102 and component 108.

Hosting relationships identify dependencies among components. In a hosting relationship, the hosting component should be present in order for the guest component to be included in the system. In FIG. 1, hosting relationships are illustrated by the vertical lines connecting component 104 and component 106, connecting component 108 and component 110, connecting component 110 and 112, and connecting component 112 and 114.

Communication relationships identify components that can communicate with one another. In FIG. 1, communication relationships are illustrated by the horizontal line connecting component 104 and component 108.

Associated with each component in SDM 100 is one or more information (info) pages. Information pages 122 are associated with component 102, information pages 124 are associated with component 104, information pages 126 are associated with component 106, information pages 128 are associated with component 108, information pages 130 are associated with component 110, information pages 132 are associated with component 112, and information pages 134 are associated with component 114. Each information page contains information about the associated component. Different types of information can be maintained for different components. In certain embodiments, different pages contain different types of information, such as one page containing installation information and another page containing constraint information. Alternatively, different types of information may be included on the same page, such as installation information and constraint information being included on the same page.

Examples of types of information pages include installation pages, constraint pages, monitoring pages, service level agreement pages, description pages, and so forth. Installation pages include information describing how to install the associated component onto another component (e.g., install an application onto a computer), such as what files to copy onto a hard drive, what system settings need to be added or changed (such as data to include in an operating system registry), what configuration programs to run after files are copied onto the hard drive, and so forth.

Constraint pages include information describing constraints for the associated component, including constraints to be imposed on the associated component, as well as constraints to be imposed on the system in which the associated component is being used (or is to be used). Constraints imposed on the associated component are settings that the component should have (or alternatively should not have) when the component is installed into a system. Constraints imposed on the system are settings that the system should have (or alternatively should not have) in order for the associated component to be used in that particular system. Constraint pages may also optionally include default values for at least some of these settings, identifying a default value to use within a range of values that satisfy the constraint. These default values can be used to assist in installation of an application, as discussed in more detail below.

Monitoring pages include information related to monitoring the performance and/or health of the associated component. This information can include rules describing how the associated component is to be monitored (e.g., what events or other criteria to look for when monitoring the component), as well as what actions to take when a particular rule is satisfied (e.g., record certain settings or what events occurred, sound an alarm, etc.).

Service level agreement pages include information describing agreements between two or more parties regarding the associated component (e.g., between the purchaser of the associated component and the seller from which the associated component was purchased). These can be accessed during operation of the system to determine, for example, whether the agreement reached between the two or more parties is being met by the parties.

Description pages include information describing the associated component, such as various settings for the component, or other characteristics of the component. These settings or characteristics can include a name or other identifier of the component, the manufacturer of the component, when the component was installed or manufactured, performance characteristics of the component, and so forth. For example, a description page associated with a component that represents a computing device may include information about the amount of memory installed in the computing device, a description page associated with a component that represents a processor may include information about the speed of the processor, a description page associated with a component that represents a hard drive may include information about the storage capacity of the hard drive and the speed of the hard drive, and so forth.

As can be seen in FIG. 1, an SDM maintains various information (e.g., installation, constraints, monitoring, etc.) regarding each component in the system. Despite the varied nature of these information pages, they are maintained together in the SDM and thus can all be readily accessed by various utilities or other applications involved in the management of the system.

An SDM can be generated and stored in any of a variety of different ways and using any of a variety of different data structures. In certain embodiments, the SDM is based on a data structure format including types, instances, and optionally configurations. Each component in the SDM corresponds to or is associated with a type, an instance, and possibly one or more configurations. Additionally, each type, instance, and configuration corresponding to a particular component can have its own information page(s). A type refers to a general template having corresponding information pages that describe the component generally. Typically, each different version of a component will correspond to its own type (e.g., version 1.0 of a software component would correspond to one type, while version 1.1 of that software component would correspond to another type). A configuration refers to a more specific template that can include more specific information for a particular class of the type. An instance refers to a specific occurrence of a type or configuration, and corresponds to an actual physical component (software, hardware, firmware, etc.).

For types, configurations, and instances associated with a component, information contained in information pages associated with an instance can be more specific or restrictive than, but cannot contradict or be broader than, the information contained in information pages associated with the type or the configuration. Similarly, information contained in information pages associated with a configuration can be more specific or restrictive than, but cannot contradict or be broader than, the information contained in information pages associated with the type. For example, if a constraint page associated with a type defines a range of values for a buffer size, the constraint page associated with the configuration or the instance could define a smaller range of values within that range of values, but could not define a range that exceeds that range of values.

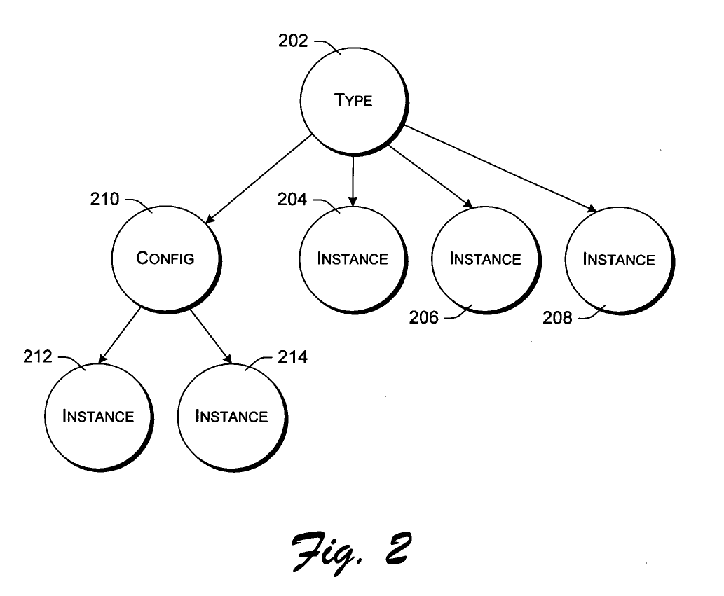

The use of types, configurations, and instances is illustrated in FIG. 2. In FIG. 2, a type 202 corresponds to a particular component. Three different instances 204, 206, and 208 of that particular component exist and are based on type 202. Additionally, a configuration (config) 210 exists which includes additional information for a particular class of the particular component, and two instances 212 and 214 of that particular class of the particular component.

For example, assume that a particular component is a database application. A type 202 corresponding to the database application is created, having an associated constraint information page. The constraint information page includes various general constraints for the database application. For example, one of the constraints may be a range of values that a particular buffer size should be within for the database application. Type 202 corresponds to the database application in general.

Each of the instances 204, 206, and 208 corresponds to a different example of the database application. Each of the instances 204, 206, and 208 is an actual database application product, and can have its own associated information pages. For example, each instance could have its own associated description information page that could include a unique identifier of the particular associated database application product. By way of another example, the constraint information page associated with each instance could include a smaller range of values for the buffer size than is indicated in the constraint information page associated with type 202.

The information pages corresponding to the instances in FIG. 2 can be in addition to, or alternatively in place of, the information pages corresponding to the type. For example, two constraint information pages may be associated with each instance 204, 206, and 208, the first constraint information page being a copy of the constraint information page associated with type 202 and the second constraint information page being the constraint information page associated with the particular instance and including constraints for just that instance. Alternatively, a single constraint information page may be associated with each instance 204, 206, and 208, the single constraint information page including the information from the constraint information page associated with type 202 as well as information specific to the particular instance. For example, the range of values that the particular buffer size should be within for the database application would be copied from the constraint information page associated with type 202 to the constraint information page associated with each instance. However, if the constraint information page for the instance indicated a different range of values for that particular buffer size, then that different range of values would remain in the constraint information page associated with the instance rather than copying the range of values from the constraint information page associated with type 202.

Following this example of a database application, configuration 210 corresponds to a particular class of the database application. For example, different classes of the database application may be defined based on the type of hardware the application is to be installed on, such as different settings based on whether the computer on which the database application is to be installed is publicly accessible (e.g., accessible via the Internet), or based on whether an operating system is already installed on the server. These different settings are included in the constraint information page associated with configuration 210.

Each of the instances 212 and 214 corresponds to a different example of the database application. Similar to instances 204, 206, and 208, each of instances 212 and 214 is an actual database application product, and can have its own information page(s). However, unlike instances 204, 206, and 208, the constraint information pages associated with instances 212 and 214 each include the constraints that are in the constraint information page associated with configuration 210 as well as the constraints in the constraint information page associated with type 202.

It should be noted that, although the information pages are discussed as being separate from the components in the SDM, the data structure(s) implementing the SDM could alternatively include the information discussed as being included in the various information pages. Thus, the component data structures themselves could include the information discussed as being included in the various information pages rather than having separate information pages.

The installation page associated with a component can be used as a basis for provisioning a system. Provisioning a system refers to installing an application(s) on the system, as well as making any necessary changes to the system in order for the application(s) to be installed. Such necessary changes can include, for example, installing an operating system, installing one or more other applications, setting configuration values for the application or operating system, and so forth.

In the discussions herein, reference is made to different classes of computing devices. Each of these different classes of computing devices refers to computing devices having particular common characteristics, so they are grouped together and viewed as a class of devices. Examples of different classes of devices include IIS (Internet Information Services) servers that are accessible to the Internet, IIS servers that are accessible only on an internal intranet, database servers, email servers, order processing servers, desktop computers, and so forth. Typically, each different class of computing device corresponds to one of the configurations in the system model.

The SDM contains static information (e.g., the topology of software services within an application) and dynamic information (e.g., the control flow of a particular transaction). This information is used to describe components, system architecture, and transaction flows (e.g., a series of steps that perform a function).

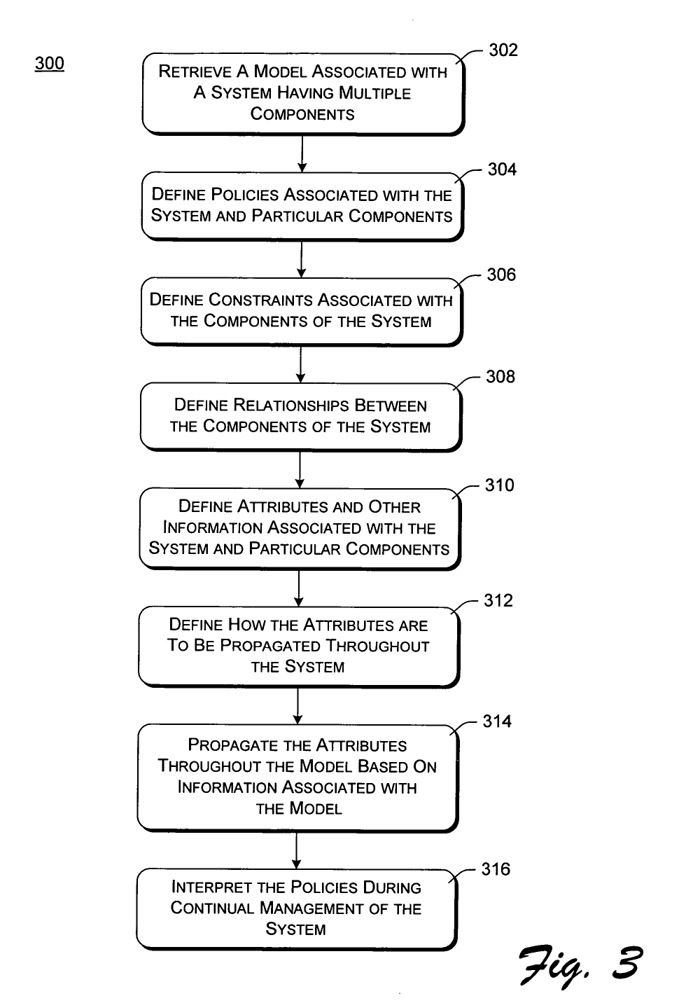

FIG. 3 is a flowchart illustrating an example process 300 for propagating attributes throughout a system model. Process 300 can be implemented in software, firmware, and/or hardware. Initially, process 300 retrieves a model associated with a system having multiple components (block 302). In one embodiment, this model is an SDM model of the type discussed above with respect to FIGS. 1 and 2. A particular model may contain any number of objects to define the associated system.

Process 300 continues by defining (or identifying) various attributes, policies, constraints, dependencies, and other information associated with the system and/or particular components of the system. This information can be defined by a system administrator, a system manager, or other person responsible for managing the system. Alternatively, this information may be retrieved (or received) from one or more data sources. In particular, process 300 defines policies associated with the system and specific components of the system (block 304). These policies may include, for example, business policies such as data backup frequency, licensing information, and whether the system is permitted to export certain data.

The process further defines constraints associated with the components of the system (block 306) and defines relationships between the various components of the system (block 308). Constraints can be defined, for example, in one or more constraint pages (discussed above), which are examples of information pages contained in SDM 100. Certain constraints may be specified as part of another model (such as an SDM model of a SQL Server database), yet those constraints also become part of this SDM model when the other model is included. A constraint can flow over a relationship. For example, if an application A has a relationship with a SQL Server S, a constraint defined for application A can reference an attribute of server S. A constraint on application A may state that application A must store its data on a RAID device. Thus, even though the SQL Server S does not itself have this RAID constraint, the constraint flows from application A to SQL Server S due to the relationship between the two items.

Dependencies include, for example, dependencies between two or more components in the system. A dependency definition may (or may not) include a reason why a particular component depends on another component. A particular dependency definition may simply identify the dependency such that if one component fails, the system can determine what other components depend on the failed component. Dependencies may also be referred to as “relationships.”

Next, process 300 defines attributes and other information associated with the system and/or particular components of the system (block 310). In one example, a system may have attributes such as business-importance, with possible values of 4 representing customer-facing-mission-critical, 3 for internal-mission-critical, 2 for internal-standard, 1 for test, and 0 for retired. The process then defines how the various attributes are to be propagated throughout the model based on one or more propagation rules (block 312). For example, if an application has a dependency on a database, a health attribute is propagated from the database to the application. If the database fails, the system can determine that the application fails as well. Business-importance is propagated in the opposite direction. For example, if the application has a business-importance rating of 3, the database gets the same rating, unless it already has a higher rating. In another implementation, an attribute propagation rule for a containment relationship may specify how a health attribute is to be propagated from the contained systems (the children) to the container (the parent). In many cases, the health monitoring systems give the parent the worst-case health value of the children. Thus, if any single child has a “red” health status, the parent gets that same health status. In some situations, when the container represents a system with a redundant architecture, health monitoring systems may implement an aggressive algorithm that recognizes the redundancy. For example, the parent only gets the “red” status if at least all three children have “red” status. The attribute propagation systems and methods discussed herein allow more flexible algorithms. For example, the systems and methods can weigh the health value of the children using the business-importance rating, or traffic volume, size, or cost of each child system when calculating the aggregate health value for the parent. In one such model, there may be a system representing all the printers in an office. When calculating the aggregate health state of printing, a large invoicing printer is more important and is given greater weight than small inkjet printers on most users' desks. The systems and methods can determine the business-importance rating, or traffic volume, size, or cost of each child by propagating attributes to other related systems, including lower-level children.

Finally, after the models, policies, constraints, attributes, and propagation rules have been defined, the process propagates the attributes throughout the model based on information contained in the model associated with the system (block 314). The process then interprets the policies during continual management of the systems (block 316). For example, information contained in SDM 100, discussed above, describes relationships and other data regarding components in the system that is useful in propagating the attributes to the appropriate objects in the system model. With this knowledge of the system architecture, the attributes are propagated throughout the model.

As mentioned above, attributes can propagate over relationships. For example, an administrator may specify that a business-importance attribute should propagate over the application-to-database communications relationship. In this example, if application A has a high business-importance rating, when application A and SQL Server S are connected with such a relationship, SQL Server S gets the same business-importance rating. Using this technique for propagating attributes, the administrator or other user can define a more meaningful policy for the database storage. Namely, SQL Server S receives a policy that indicates “if my business-importance rating is 4, then I must use a RAID device to host the data.” This expresses the desired policy, but keeps the internal details of the SQL Server out of the policies associated with the application.

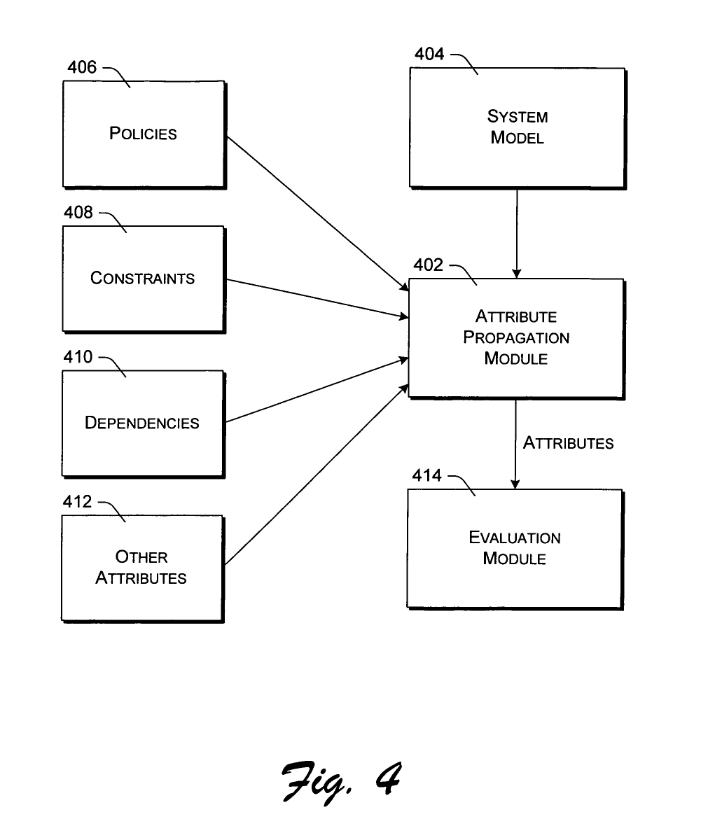

FIG. 4 illustrates an example attribute propagation module 402 that receives a system model and various attributes, and propagates attributes throughout the model. Attribute propagation module 402 receives system model information, such as information contained in an SDM. Additionally, attribute propagation module 402 receives policy information 406, constraint information 408, dependency information 410, and information regarding other attributes 412. Attribute propagation module 402 then distributes one or more attributes to an evaluation module 414, which evaluates constraints and policies based on the attribute values. Evaluation module 414 detects deviations in any constraints or policies and takes appropriate action to correct the deviation. Alternatively, evaluation module 414 may bring the deviation to the attention of an administrator or other user.

For example, two different applications (application A and application B) both use a SQL Server database and the database uses a disk drive to host the data. If application A has a business-importance rating of 1, and application B has a business-importance rating of 2, the database gets the highest of these two ratings, which is 2. When application A is released to production, its business-importance rating is raised to 4, representing customer-facing-mission-critical, and this rating is propagated to the database. If there is a policy that every database with business-importance of 4 must be stored on a RAID storage subsystem, the evaluation module detects that a change to one of the applications caused the database to be out of compliance with a policy. The evaluation module then initiates actions to correct that situation or notify an administrator of the situation. If, at a later time, Application A is removed or no longer connected to the database, the database gets a lower business-importance rating and no longer requires a costly RAID storage device. Having a RAID storage device is not a violation of the initial policy, but it is unnecessary, and there may be another policy that databases should not use RAID storage devices unless their business-importance rating is high enough.

In another example, the propagated attribute is communicated to an administrator when a constraint violation is detected, but not used in the analysis. The database may have a simpler constraint that is not dependent on any propagated attribute, such as “the journaling file should not be installed on a compressed drive.” The corrective action for this constraint may be specified as “notify the administrator with a warning” because the rule is not important (not classified as a serious error). In this situation, the management system should not take any form of automated corrective action or otherwise enforce the policy. However, if the rule indicates that the business-importance attribute should be included in the notification to the administrator, the administrator may decide to give the violation greater attention for a mission-critical database than for other databases.

In yet another example, an attribute may influence the schedule by which a management action is taken. If many systems are found to be in violation of a particular security policy, and correcting that violation requires manual intervention, the systems with high business-importance may be prioritized ahead of other systems.

In a particular implementation, attribute propagation module 402 may not receive one or more of: policy information 406, constraint information 408, dependency information 410, or information regarding other attributes 412. Attribute propagation module 402 may receive policy information 406, constraint information 408, dependency information 410, and information regarding other attributes 412 from any number of sources. In other embodiments, attribute propagation module 402 receives additional information not shown in FIG. 4.

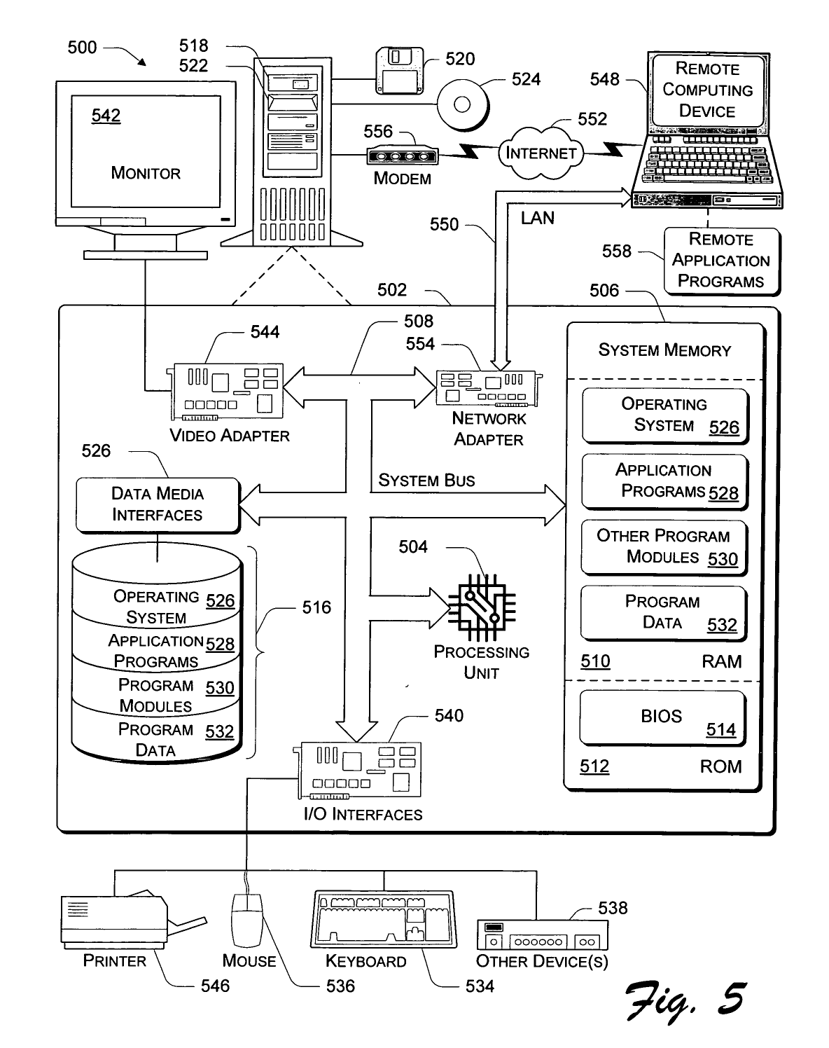

FIG. 5 illustrates an example general computer environment 500, which can be used to implement the techniques described herein. The computer environment 500 is only one example of a computing environment and is not intended to suggest any limitation as to the scope of use or functionality of the computer and network architectures. Neither should the computer environment 500 be interpreted as having any dependency or requirement relating to any one or combination of components illustrated in the example computer environment 500.

Computer environment 500 includes a general-purpose computing device in the form of a computer 502. Computer 502 can be, for example, a desktop computer, a handheld computer, a notebook or laptop computer, a server computer, a game console, and so on. The components of computer 502 can include, but are not limited to, one or more processors or processing units 504, a system memory 506, and a system bus 508 that couples various system components including the processor 504 to the system memory 506.

The system bus 508 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 502 typically includes a variety of computer readable media. Such media can be any available media that is accessible by computer 502 and includes both volatile and non-volatile media, removable and non-removable media.

The system memory 506 includes computer readable media in the form of volatile memory, such as random access memory (RAM) 510, and/or non-volatile memory, such as read only memory (ROM) 512. A basic input/output system (BIOS) 514, containing the basic routines that help to transfer information between elements within computer 502, such as during start-up, is stored in ROM 512. RAM 510 typically contains data and/or program modules that are immediately accessible to and/or presently operated on by the processing unit 504.

Computer 502 may also include other removable/non-removable, volatile/non-volatile computer storage media. By way of example, FIG. 5 illustrates a hard disk drive 516 for reading from and writing to a non-removable, non-volatile magnetic media (not shown), a magnetic disk drive 518 for reading from and writing to a removable, non-volatile magnetic disk 520 (e.g., a “floppy disk”), and an optical disk drive 522 for reading from and/or writing to a removable, non-volatile optical disk 524 such as a CD-ROM, DVD-ROM, or other optical media. The hard disk drive 516, magnetic disk drive 518, and optical disk drive 522 are each connected to the system bus 508 by one or more data media interfaces 526. Alternatively, the hard disk drive 516, magnetic disk drive 518, and optical disk drive 522 can be connected to the system bus 508 by one or more interfaces (not shown).

The disk drives and their associated computer-readable media provide non-volatile storage of computer readable instructions, data structures, program modules, and other data for computer 502. Although the example illustrates a hard disk 516, a removable magnetic disk 520, and a removable optical disk 524, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 516, magnetic disk 520, optical disk 524, ROM 512, and/or RAM 510, including by way of example, an operating system 526, one or more application programs 528, other program modules 530, and program data 532. Each of such operating system 526, one or more application programs 528, other program modules 530, and program data 532 (or some combination thereof) may implement all or part of the resident components that support the distributed file system.

A user can enter commands and information into computer 502 via input devices such as a keyboard 534 and a pointing device 536 (e.g., a “mouse”). Other input devices 538 (not shown specifically) may include a microphone, joystick, game pad, satellite dish, serial port, scanner, and/or the like. These and other input devices are connected to the processing unit 504 via input/output interfaces 540 that are coupled to the system bus 508, but may be connected by other interface and bus structures, such as a parallel port, game port, or a universal serial bus (USB).

A monitor 542 or other type of display device can also be connected to the system bus 508 via an interface, such as a video adapter 544. In addition to the monitor 542, other output peripheral devices can include components such as speakers (not shown) and a printer 546 which can be connected to computer 502 via the input/output interfaces 540.

Computer 502 can operate in a networked environment using logical connections to one or more remote computers, such as a remote computing device 548. By way of example, the remote computing device 548 can be a personal computer, portable computer, a server, a router, a network computer, a peer device or other common network node, and the like. The remote computing device 548 is illustrated as a portable computer that can include many or all of the elements and features described herein relative to computer 502.

Logical connections between computer 502 and the remote computer 548 are depicted as a local area network (LAN) 550 and a general wide area network (WAN) 552. Such networking environments are commonplace in offices, enterprise-wide computer networks, intranets, and the Internet.

When implemented in a LAN networking environment, the computer 502 is connected to a local network 550 via a network interface or adapter 554. When implemented in a WAN networking environment, the computer 502 typically includes a modem 556 or other means for establishing communications over the wide network 552. The modem 556, which can be internal or external to computer 502, can be connected to the system bus 508 via the input/output interfaces 540 or other appropriate mechanisms. It is to be appreciated that the illustrated network connections are exemplary and that other means of establishing communication link(s) between the computers 502 and 548 can be employed.

In a networked environment, such as that illustrated with computing environment 500, program modules depicted relative to the computer 502, or portions thereof, may be stored in a remote memory storage device. By way of example, remote application programs 558 reside on a memory device of remote computer 548. For purposes of illustration, application programs and other executable program components such as the operating system are illustrated herein as discrete blocks, although it is recognized that such programs and components reside at various times in different storage components of the computing device 502, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Alternatively, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
identifying a model of a system that includes a plurality of components, wherein the model is a system definition model that describes the system;
identifying a plurality of attributes associated with the system;
determining a manner in which the plurality of attributes are to be propagated throughout the model; and
propagating the plurality of attributes throughout the model based on information associated with the model.

2. A method as recited in claim 1, further comprising identifying a business policy associated with the system.

3. A method as recited in claim 1, further comprising identifying a constraint associated with a particular component of the system.

4. A method as recited in claim 1, further comprising identifying a dependency between at least two components of the system.

5. A method as recited in claim 1, wherein the plurality of attributes are defined during development of the model of the system.

6. A method as recited in claim 1, wherein identifying a plurality of attributes associated with the system includes:
accessing a constraint information page in the model of the system; and
accessing a description page in the model of the system, wherein the description page is associated with at least one component of the system.

7. A method as recited in claim 1, wherein each of the plurality of components in the system has an associated page of data that defines an operation of the component.

8. A method as recited in claim 1, wherein each of the plurality of components in the system has an associated page of data that identifies relationships with other components in the system.

9. A method as recited in claim 1, further comprising interpreting policies and generating a message in response to a violated policy.

10. A method comprising:
identifying a model of a system that includes a plurality of components, wherein the model is a system definition model that describes the system;
identifying a plurality of attributes associated with the system;
identifying relationships between components of the system; and
propagating the plurality of attributes throughout the model based on information contained in the model of the system and the identified relationships between components in the system.

11. A method as recited in claim 10, wherein at least one of the plurality of attributes is a business-importance rating.

12. A method as recited in claim 10, further comprising interpreting a plurality of policies associated with the system.

13. A method as recited in claim 12, further comprising generating an alert upon detecting a violation of at least one of the plurality of policies associated with the system.

14. A method as recited in claim 10, wherein propagating the plurality of attributes throughout the model includes retrieving information pages associated with a plurality of components in the system.

15. A method as recited in claim 10, wherein each of the plurality of components in the system has a first associated page of data that defines an operation of the component and a second associated page of data that identifies relationships with other components in the system.

16. One or more computer readable media having stored thereon a plurality of instructions that, when executed by one or more processors, causes the one or more processors to:
retrieve a model of a system, wherein the model includes definitions of a plurality of components contained in the system;
identify a plurality of policies associated with the system;
identify a plurality of attributes associated with the system;
identify a plurality of relationships between components of the system; and
propagate the attributes throughout the model based on information associated with the model of the system.

17. One or more computer readable media as recited in claim 16, wherein the model of the system includes an information page associated with each component in the system, and wherein each information page defines an operation of the associated component.

18. One or more computer readable media as recited in claim 16, wherein the plurality of policies include business policies that restrict the operation of the system.

19. One or more computer readable media as recited in claim 16, wherein the one or more processors further propagate the attributes throughout the model based on relationships between components of the system.

20. One or more computer readable media as recited in claim 16, wherein the one or more processors further interpret the plurality of policies and check for compliance with the plurality of policies.
